(19) United States
(12) Patent Application Publication
(10) Pub. No.: US 2026/0037844 A1
(43) Pub. Date: Feb. 5, 2026

(54) SUBSTRATE PROCESSING DEVICE INCLUDING MULTIPLE SENSORS AND METHOD OF OPERATING THE SAME

(71) Applicant: Samsung Electronics Co., Ltd., Suwon-si (KR)

(72) Inventors: Myung Geun SONG, Suwon-si (KR); Min Jun KWAK, Suwon-si (KR); Sa Rah KIM, Suwon-si (KR); Sun Jung KIM, Suwon-si (KR); Young Hoon KIM, Suwon-si (KR); Chang Yul KIM, Suwon-si (KR); Hyeon Joong KIM, Suwon-si (KR); Jae Seok PARK, Suwon-si (KR); Jae Yong PARK, Suwon-si (KR); Jung Min LEE, Suwon-si (KR)

(21) Appl. No.: 19/020,061

(22) Filed: Jan. 14, 2025

(30) Foreign Application Priority Data
Aug. 2, 2024 (KR) 10-2024-0103205

(51) Int. Cl. G06N 7/01

(52) U.S. Cl. CPC G06N 7/01

(57) ABSTRACT

A method includes generating first rarity data from first time series data acquired from a first source of a substrate processing device, the first time series data including a plurality of first component data acquired at a plurality of time points, the first rarity data indicating how rare each of the plurality of first component data is; generating second rarity data from second time series data acquired from a second source of the substrate processing device, the second time series data including a plurality of second component data acquired at a plurality of time points, the second rarity data indicating how rare each of the plurality of second component data is; generating first binary data on the basis of the first rarity data; generating second binary data on the basis of the second rarity data; generating a synchronization rate between the first time series data and the second time series data, by the use of the first binary data and the second binary data; and initiating a maintenance operation for the first source, the second source or the substrate processing device based on the first binary data, the second binary data, and the synchronization rate.

### CROSS-REFERENCE TO RELATED APPLICATION

This application claims priority from Korean Patent Application No. 10-2024-0103205, filed Aug. 2, 2024, in the Korean Intellectual Property Office, and all the benefits accruing therefrom under 35 U.S.C. 119, the contents of which in its entirety are herein incorporated by reference.

### BACKGROUND

### 1. Field of the Invention

The present invention relates to a data analysis method for use with a substrate processing device including multiple sensors.

### 2. Description of the Related Art

A substrate processing device may be provided with tens to hundreds of sensors. These sensors generate time series data by performing measurement operations for preset time intervals. The time series data of the sensors are analyzed to check the status of the substrate processing device.

### SUMMARY

Aspects of the present invention provide a method for operating a substrate processing device including multiple sensors and processing and analyzing data acquired therefrom that may improve analysis accuracy and operational performance of the substrate processing device.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

A method according to some embodiments of the inventive concept includes generating first rarity data from first time series data acquired from a first source of a substrate processing device, the first time series data including a plurality of first component data acquired at a plurality of time points, the first rarity data indicating how rare each of the plurality of first component data is; generating second rarity data from second time series data acquired from a second source of the substrate processing device, the second time series data including a plurality of second component data acquired at a plurality of time points, the second rarity data indicating how rare each of the plurality of second component data is; generating first binary data on the basis of the first rarity data; generating second binary data on the basis of the second rarity data; generating a synchronization rate between the first time series data and the second time series data, by using the first binary data and the second binary data; and initiating a maintenance operation for the first source, the second source, or the substrate processing device based on the first binary data, the second binary data, and the synchronization rate.

A method according to some embodiments of the inventive concept includes generating a plurality of rarity data on the basis of a plurality of time series data sets, each of the plurality of time series data sets is acquired from a corresponding sensor among a plurality of sensors of a substrate processing device, and each rarity data item indicates how rare each component data item of the time series data is; generating a plurality of binary data based on the plurality of rarity data; calculating a synchronization rate between the plurality of time series data sets, using the plurality of binary data; determining that ones of the plurality of time series data sets whose calculated synchronization rate is greater than a preset reference value are in a state of being synchronized with each other; clustering sensors of the plurality of sensors corresponding to the synchronized ones of the plurality of time series data sets; and initiating a maintenance operation for one or more of the plurality of sensors of the substrate processing device based on the plurality of binary data and the synchronization rate between the plurality of time series data sets, wherein the calculation of the synchronization rate includes calculating an inner product between the plurality of binary data represented by vectors.

A method, comprising: generating a plurality of binary data corresponding to a plurality of sensors of a substrate processing device, the binary data indicating whether a singularity is sensed in the corresponding sensor and a time point at which the singularity is sensed; determining a correlation between the corresponding plurality of sensors based on an inner product between the plurality of binary data; clustering the sensors determined to be correlated; and initiating a maintenance operation for one or more of the plurality of sensors or the substrate processing device based on the binary data and the correlation between ones of the plurality of sensors.

Specific features of other embodiments are included in the detailed description and drawings.

### BRIEF DESCRIPTION OF THE DRAWINGS

The above and other aspects and features of the present invention will become more apparent by describing in detail example embodiments thereof referring to the attached drawings, in which:

FIG. 1 is a flowchart that illustrates operations of a data analysis method according to some embodiments of the inventive concept;

FIG. 2 is a flowchart illustrating further operations of the data analysis method according to some embodiments of the inventive concept;

FIGS. 3 and 4 are graphs that illustrate a method for calculating binary data from time series data according to some embodiments of the inventive concept;

FIGS. 5 to 7 are graphs that illustrate a data analysis method according to some embodiments of the inventive concept;

FIG. 8 is a block diagram that illustrates a relationship between a data analysis device and a substrate processing device according to some embodiments of the inventive concept;

FIG. 9 is a block diagram that illustrates the data analysis device of FIG. 8 according to some embodiments of the inventive concept; and

FIG. 10 is a block diagram that illustrates a controller of FIG. 9 according to some embodiments of the inventive concept.

### DETAILED DESCRIPTION OF THE EMBODIMENTS

Hereinafter, embodiments of the present invention will be described in detail referring to the accompanying drawings. The same reference numerals are used for the same components in the drawings, and repeated explanations thereof will not be provided. It is noted that aspects described with respect to one embodiment may be incorporated in different embodiments although not specifically described relative thereto. That is, all embodiments and/or features of any embodiments can be combined in any way and/or combination.

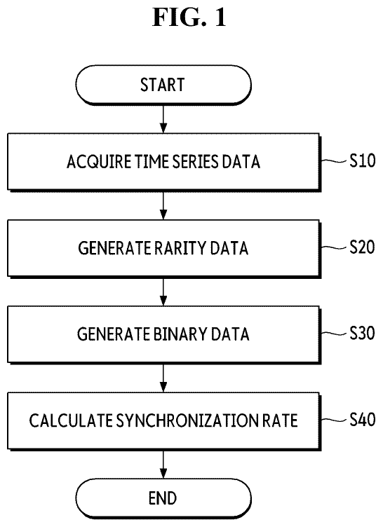

FIG. 1 is a flowchart that illustrates operations of a data analysis method according to some embodiments of the inventive concept.

Referring to FIG. 1, first, a plurality of time series data SD are acquired (S10).

Specifically, each of the plurality of time series data SD may be provided from a different source. For example, the plurality of time series data SD may be provided from a plurality of sensors installed in the substrate processing device, but embodiments are not limited thereto. For example, the individual data items in a first plurality of time series data SD may be obtained from a first one of the plurality of sensors, the individual data items in a second plurality of time series data SD may be obtained from a second one of the plurality of sensors, and an Nth plurality of time series data SD may be obtained from an Nth one of the plurality of sensors.

As in Table 1, each time series data set SD may include a plurality of measured values (or component data) (X1, X2, X3, . . . , Xm) measured at a plurality of time points (t1, t2, t3, . . . , tm) (here, m is a natural number of 2 or more). In other words, when the time series data SD is expressed as a vector {X1, X2, X3, . . . , Xm}, a measured value X1 may be measured at time t1, a measured value X2 may be measured at time t2, a measured value X3 may be measured at time t3, and a measured value Xm may be measured at time tm. The plurality of times (t1, t2, t3, . . . , tm) may be preset time points, for example, time points corresponding to preset time intervals (for example, 1 second, 0.1 second, etc.).

TABLE 1

| Measured time point | t1 | t2 | t3 | . . . | tm |
|---|---|---|---|---|---|
| Measured value | X1 | X2 | X3 | . . . | Xm |

Next, a plurality of rarity data RD are generated on the basis of the plurality of time series data SD (S20).

Here, the rarity data RD are data indicating how rare each measured value (or component data) (e.g., Xm) measured at each measured time point (e.g., tm) is. For example, when data X1 to X5 are measured as “3” at five time points t1 to t5, if data X6 is measured as “3” at a sixth time point t6, “3” is not rare. However, if data X6 is measured as “9” at the sixth time point t6, the measurement of “9” may be determined to be rare. Whether a data (e.g., Xm) measurement is rare may be determined by comparing it with data measured before the determination or measurement of target data (Xm) (e.g., Xm−1, Xm−2) and/or data measured after that (e.g., Xm+1, Xm+2). That is, sensor measurements that precede a target data measurement in time and sensor measurements that are subsequent to the target measurement in time may be used to determine the rarity of the particular measurement

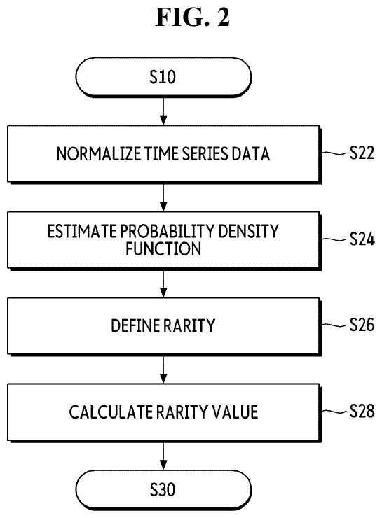

A method for generating the rarity data RD according to some embodiments of the inventive concept will be described in more detail referring to FIG. 2.

Referring to FIG. 2, a normalization is performed for each of the plurality of time series data SD (S22). This is because the plurality of time series data SD are provided from the plurality of sources, and therefore physical quantities or units represented by each of the plurality of time series data SD may differ based on differences between the different sources or sensors.

As in Table 2, the measured values (or component data) (X1, X2, X3, . . . , Xm) of each time series data SD may be converted into normalized measured values (or normalized component data) (nX1, nX2, nX3, . . . , nXm). The normalized time series data nSD may be represented by vector {nX1, nX2, nX3, . . . , nXm}.

TABLE 2

| Measured time point | t1 | t2 | t3 | . . . | tm |
|---|---|---|---|---|---|
| Normalized measured value | nX1 | nX2 | nX1 | . . . | nXm |

According to some embodiments of the inventive concept, normalization using hyperbolic tangent may be performed, without performing normalization using a simple min-MAX or using a standard deviation. Referring to the hyperbolic tangent function, when the x value is near zero, a y value has a linear characteristic, and when an x value is equal to or greater than a certain value, the y value converges to +1 or −1. Therefore, even if the x value is infinity (+inf, −inf), the y value becomes +1 or −1.

Thus, when the normalization using the hyperbolic tangent is performed, the normalized measured value (e.g., nXm) may correspond to +1 or −1, even if a certain measured value (e.g., Xm) of the time series data SD has a value close to infinity (+inf, −inf).

Next, the probability density function associated with the normalized measured values (nX1, nX2, nX3, . . . , nXm) is estimated (S24). That is, the distribution characteristics of the original variables of the normalized measured values (nX1, nX2, nX3, . . . , nXm) are estimated (i.e., density estimation).

For example, the density may be estimated, using a parametric method or a non-parametric method. The parametric method is a method in which a model for a probability density function is defined in advance, and only the parameters of this model are estimated. The non-parametric method does not define a model for the probability density function in advance.

In some embodiments of the inventive concept, the density estimation may be performed, using the non-parametric method. For example, by performing the density estimation using the kernel function, the probability density function of normalized measured values (nX1, nX2, nX3, . . . , nXm) may be estimated. The probability density function estimated in this way is called pdfbox(t, v). pdfbox(t, v) means the probability of having a value v at the measured time point t.

Then, the rarity is defined using the estimated probability density function (S26).

In some embodiments, the rarity (Rarity(t, v)) may be calculated by the following [Formula 1].

$$Rarity ( t , v ) = \frac{- log ( std ( t ) ) * pdfbox ( t , v ) + {e}^{- sensitivity}}{sensitivity} \qquad [ Formula 1 ]$$

Here, Rarity(t, v) indicates how rare the value v represents at the measured time point t. std(t) represents a standard deviation of the time series data, pdfbox(t, v) represents a probability density function estimated in the previous operation (S24), and sensitivity represents a correction parameter of the corresponding sensor. The correction parameter is associated with the characteristics of the corresponding sensor, such as sensor noise and sensor sensitivity.

[Formula 1] reflects the variability of the sensor by multiplying the probability density function by the standard deviation. In addition, by adding e^{-sensitivity}, the rarity value is corrected so that it does not become infinite (i.e., so that there is a maximum value). In addition, by dividing the rarity value by sensitivity, Rarity(t, v) exists between 0 and 1.

The rarity (Rarity(t, v)) indicates how unusual a measured value having a value of v at time point t is. If the value of v is a value indicated in a normal time series profile, the rarity has a large value. However, if the value of v is significantly different from surrounding values (e.g., measured values at earlier time points (e.g., t−1, t−2) or later time points (e.g., t+1, t+2)), the rarity has a small value. If the value of v is a normally rare point, the rarity has a small value. That is, if the value of v is a usually indicated value, it is close to 1, and if it is a value that is usually not seen, it is close to 0.

Next, the rarity value is calculated using the rarity (Rarity(t, v)) to generate rarity data RD (S28).

The rarity data RD includes a plurality of rarity values (R1, R2, R3, . . . , Rm) that indicate how rare the plurality of measured values (X1, X2, X3, . . . , Xm) measured at the plurality of time points (t1, t2, t3, . . . , tm) are (see Table 3). That is, the rarity value at time t1 is R1, the rarity value at time t2 is R2, the rarity value at time t3 is R3, and the rarity value at time tm is Rm. The rarity data RD may be represented by a vector {R1, R2, R3, . . . , Rm}.

TABLE 3

| Measured time point | t1 | t2 | t3 | . . . | tm |
|---|---|---|---|---|---|
| Rarity value | R1 | R2 | R3 | . . . | Rm |

Referring again to FIG. 1, binary data BD is generated using the generated rarity data RD (S30).

When subtracting each rarity value (i.e., vector component) of the vector {R1, R2, R3, . . . , Rm}, which are the rarity data RD, from 1, vector {1−R1, 1−R2, 1−R3, . . . , 1−Rm} is generated. Each component of the vector {1−R1, 1−R2, 1−R3, . . . , 1−Rm} is converted into binary to generate a vector {B1, B2, B3, . . . , Bm} (i.e., binary data BD) consisting of 0 and 1. For example, one-hot encoding may be performed to generate the vector {B1, B2, B3, . . . , Bm} (i.e., binary data (BD)).

Here, if the value (v) measured at time (t) is rare, each component (e.g., 1−Rm) in the vector {1−R1, 1−R2, 1−R3, . . . , 1−Rm} approaches 1.

One-hot encoding assigns a value of 1 when each component in the vector {1−R1, 1−R2, 1−R3, . . . , 1−Rm} is equal to or greater than a preset reference value, and assigns a value of 0 when it is equal to or less than the preset reference value. The binary data BD generated by one-hot encoding may be as in [Table 4], and the binary values (B1, B2, B3, . . . , Bm) of the binary data BD are 0 or 1. That is, a binary value at time t1 is B1, a binary value at time t2 is B2, a binary value at time t3 is B3, and a binary value at time tm is Bm.

TABLE 4

| Measured time point | t1 | t2 | t3 | . . . | tm |
|---|---|---|---|---|---|
| Binary value | B1 | B2 | B3 | . . . | Bm |

One-hot encoding has been described as being performed on the vector {1−R1, 1−R2, 1−R3, . . . , 1−Rm}, but, in other embodiments, one-hot encoding may also be performed on the vector {R1, R2, R3, . . . , Rm}. In such a case, if each component of the vector {R1, R2, R3, . . . , Rm} is equal to or less than a reference value, 1 may be assigned, and if it is equal to or greater than the reference value, 1 may be assigned.

The binary data BD generated on the basis of the time series data SD indicates whether a singularity occurs in the time series data SD and the time point at which the singularity occurs (measured time point). For example, if the binary data BD1={0, 1, 1, . . . , 0}, it indicates that no singularity occurs at the first measured time point, and that a singularity occurs at the second/third measured time points.

In summary, it is assumed that a plurality of time series data (SD1, SD2, SD3, . . . , SDm) are provided from a plurality of sources, respectively. That is, the time series data (SD1, SD2, SD3, . . . , SDm) may be provided from m sources or sensors. Through the aforementioned processes of (S10, S20, and S30), a plurality of binary data (BD1, BD2, BD3, . . . , BDm) corresponding to each of the plurality of time series data (SD1, SD2, SD3, . . . , SDm) are generated. That is, first binary data BD1 corresponding to the first source or the first time series data SD1, second binary data BD2 corresponding to the second source or the second time series data SD2, third binary data BD3 corresponding to the third source or the third time series data SD3, and m-th binary data BDm corresponding to the m-th source or the m-th time series data SDm are generated.

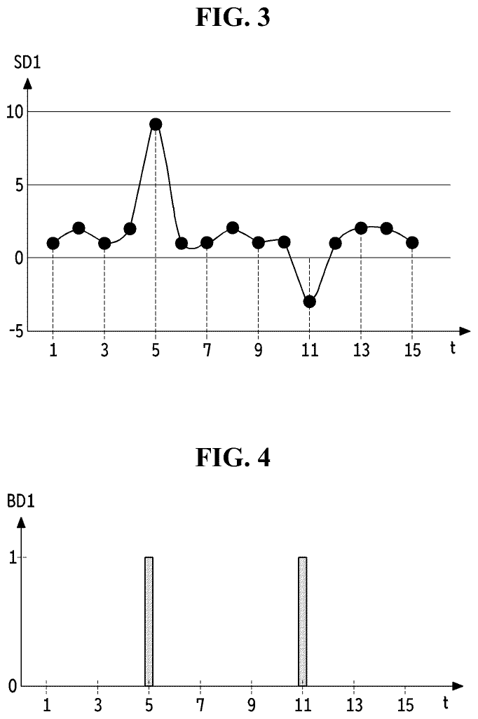

Hereinafter, a process of calculating the binary data (e.g., BD1) from the time series data (e.g., SD1) will be described referring to FIGS. 3 and 4. FIGS. 3 and 4 are graphs that illustrate a method for calculating the binary data from the time series data.

For example, it is assumed that the time series data SD1 is as in [Table 5]. The time series data SD1 is as shown in FIG. 3. Referring to FIG. 3, it may be seen that a peak is formed in an upward direction at a measured time point t5, and a peak is formed in a downward direction at a measured time point t11.

TABLE 5

| t | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| SD1 | 1 | 2 | 1 | 2 | 9 | 1 | 1 | 2 | 1 | 1 | −3 | 1 | 2 | 2 | 1 |

Each measured value of the time series data SD1 is normalized, the probability density function associated with the normalized measured value is estimated, the rarity is defined by using the probability density function, and the rarity data RD1 is calculated by using the defined rarity. The time series data SD1 calculated from the time series data SD1 is as shown in [Table 6].

TABLE 6

| t | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| RD1 | 0.78 | 0.67 | 0.88 | 0.74 | 0.08 | 0.6 | 0.7 | 0.74 | 0.8 | 0.78 | 0.1 | 0.77 | 0.87 | 0.81 | 0.74 |

Each component data of the rarity data RD1 is subtracted from 1, and one-hot encoding is performed to calculate the binary data BD1. The calculated binary data BD1 is as shown in [Table 7]. The binary data BD1 is as shown in FIG. 4. Referring to FIG. 4, it may be seen that the binary data BD1 has 1 only at the measured time points t5 and t11, and is 0 at the remaining measured time points. It may be seen that the binary data BD1 becomes 1 only at the measured time point on which a singularity (for example, when a peak is formed in the upward or downward direction) appears in FIG. 3.

TABLE 7

| t | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| BD1 | 0 | 0 | 0 | 0 | 1 | 0 | 0 | 0 | 0 | 0 | 1 | 0 | 0 | 0 | 0 |

Referring again to FIG. 1, a synchronization rate (sync) between the plurality of time series data (SD1, SD2, SD3, . . . , SDm) is calculated using the generated plurality of binary data (BD1, BD2, BD3, . . . , BDm) (S40).

Specifically, the binary data (BD1, BD2, BD3, . . . , BDm) are generated from each of the time series data (SD1, SD2, SD3, . . . , SDm) via the above-mentioned operations (S10, S20, and S30). In this state, to calculate the synchronization rate (sync) of the plurality of time series data (e.g., SD1, SD2) selected from the plurality of time series data (SD1, SD2, SD3, . . . , SDm), binary data BD1 and BD2 corresponding to the selected time series data SD1 and SD2 are used. For example, the synchronization rate (sync) of the selected several time series data SD1 and SD2 may be determined on the basis of the inner product of the corresponding binary data BD1 and BD2.

$$sync ( SD 1 , SD 2 ) = \frac{{〈 BD 1 , BD 2 〉}^{2}}{〈 BD 1 , BD 1 〉 〈 BD 2 , BD 2 〉} \qquad [ Formula 2 ]$$

In Formula 2, sync (SD1, SD2) means the synchronization rate between the first time series data SD1 and the second time series data SD2. In addition, < > means the inner product, <BD1, BD2> means the square of the inner product between the first binary data BD1 and the second binary data BD2, <BD1, BD1> is the square of the absolute value of the first binary data BD1, and <BD2, BD2> is the square of the absolute value of the second binary data BD2.
sync(SD1, SD2) may have a value between 0 and 1 because <BD1, BD2>2 is divided by <BD1, BD1><BD2, BD2>. When sync(SD1, SD2) is 1, SD1 and SD2 are in a completely synchronized state, and when sync(SD1, SD2) is 0, SD1 and SD2 are in a completely desynchronized state.

For example, each two of the m time series data (SD1, SD2, SD3, . . . , SDm) may be selected to calculate the synchronization rate (sync). As in [Table 8], the synchronization rate of SD1 and SD2 may be Q1, the synchronization rate of SD1 and SD3 may be Q2, the synchronization rate of SD1 and SD4 may be Q3, and the synchronization rate of SDm−1 and SDm may be Qw.

TABLE 8

Selected time series data

| | SD1, | SD1, | SD1, | | SDₘ₋₁, |
|---|---|---|---|---|---|
| | SD2 | SD3 | SD4 | . . . | SDm |
| Synchronization rate | Q1 | Q2 | Q3 | . . . | Qw |

Then, if the calculated synchronization rate is equal to or greater than a preset reference value, the corresponding time series data may be determined to be in a state of being synchronized with each other. For example, assuming that the reference value is 0.8, sync(SD1, SD2) is 0.82, sync(SD1, SD3) is 0.32, sync(SD1, SD4) is 0.11, and sync(SDm−1, SDm) is 0.9, it may be determined that SD1 and SD2 are synchronized with each other, and SDm−1 and SDm are synchronized with each other.

Sources (or sensors) corresponding to the time series data determined to be synchronized are determined to be associated with each other, and associated sources are clustered.

The clustered sources are subject to cross-checking when analyzing the time series data acquired from the sources. For example, a substrate processing device may be provided with a plurality of sensors, and an abnormality may be observed in the time series data acquired by a certain sensor. Here, it is difficult to determine whether there is a sensor error or an abnormality has occurred in the substrate processing device. In such a case, the time series data of other sensors clustered with the sensor are analyzed, and if an abnormality is found in the time series data of other sensors, it may be determined that an abnormality is found in the substrate processing device. If no abnormality is found in the time series data of other sensors, a sensor error may be determined. An error or abnormality may be indicated by a singularity in the binary data BD corresponding, for example, to a measurement at a particular time point having a low rarity value, i.e., the measurement value was unexpected or usually not seen. Thus, in some embodiments, one or more maintenance operations may be initiated and/or performed on any source or sensor associated with an error or abnormality and/or one or more maintenance operations may be initiated and/or performed on the substrate processing device based on any errors or abnormalities determined for any of the sources or sensors. Advantageously, the data analysis method, according to embodiments of the inventive concept, may allow the maintenance operations to be targeted to particular sources, sensors, or areas of the substrate processing device that may be defective or not operating correctly. The synchronization information may be used to determine whether abnormalities or errors are problems with an individual sensor or source, a problem with the substrate processing device, are problems with both the sensor(s) and the substrate processing device, or that the abnormalities or errors are not indicative of a problem that needs attention through a maintenance operation. For example, if multiple sensors are found to be highly synchronized with respect to singularities, then this may indicate that the sensors are operating properly, but there may be a problem with the substrate processing device or the way in which the substrate processing device is being operated as it may be unlikely that many sensors produce singularities at the same time. If, however, a sensor is generating singularities, but is not in sync with other sensors, then this sensor may need maintenance or replacement.

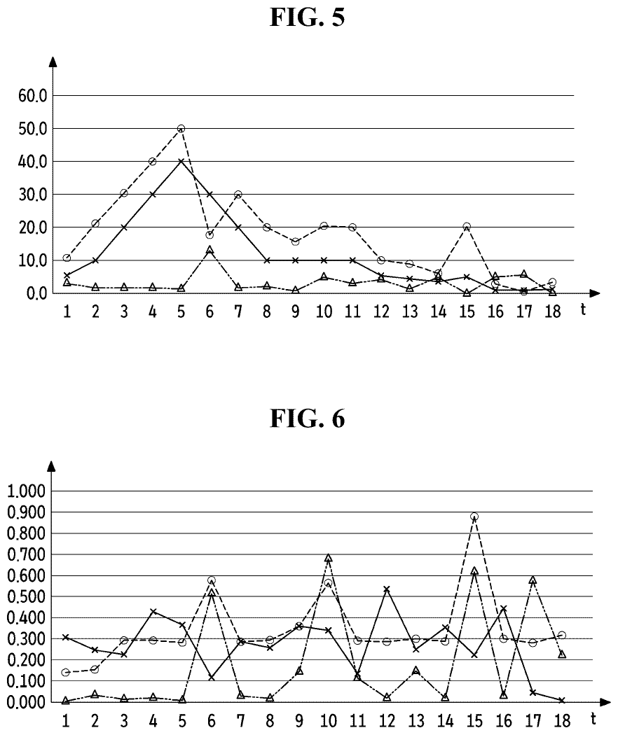

The data analysis method for the present invention will be described below, for example, referring to FIGS. 5 to 7. FIGS. 5 to 7 are graphs that illustrate the data analysis method according to some embodiments of the inventive concept.

In FIGS. 5, 6, and 7, ∘ corresponds to time series data A, X corresponds to time series data B, and Δ corresponds to time series data C.

Assume that three time series data (A, B, C) are provided from three sources (see [Table 9]). The three time series data (A, B, C) are shown in FIG. 5. Referring to FIG. 5, the time series data (A, B) look similar to each other, and time series data C looks similar to other time series data (A, B). A correlation coefficient between time series data (A, B) is 0.8841, and meanwhile, a correlation coefficient between time series data (A, C) is just 0.243.

TABLE 9

| t | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|
| A | 10.8 | 21.7 | 30.9 | 40.6 | 50.2 | 18.3 | 30.4 | 20.3 | 15.9 | 20.9 | 20.3 | 10.2 | 9.1 | 6.1 | 20.8 | 2.9 | 0.5 | 3.5 |
| B | 5.8 | 10.1 | 20.6 | 30.5 | 40.3 | 30.3 | 20.3 | 10.4 | 10.6 | 10.4 | 10.8 | 5.2 | 4.5 | 3.6 | 5.1 | 1.2 | 0.8 | 1.0 |
| C | 3.1 | 1.9 | 2.0 | 1.7 | 1.4 | 13.3 | 1.4 | 2.0 | 0.7 | 4.8 | 3.2 | 4.6 | 1.4 | 5.0 | −1.7 | 5.2 | 5.6 | −0.2 |

Next, after calculating the rarity data of the time series data (A, B, C), the values acquired by subtracting each component data of the rarity data from 1 are shown in [Table 10]. Measurements with values of 0.5 or more are shown in bold type. Each component of [Table 10] are shown in FIG. 6.

TABLE 10

| t | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|
| A | 0.139 | 0.151 | 0.295 | 0.292 | 0.283 | 0.579 | 0.285 | 0.295 | 0.359 | 0.572 | 0.295 | 0.289 | 0.302 | 0.290 | 0.881 | 0.307 | 0.291 | 0.310 |
| 8 | 0.308 | 0.249 | 0.227 | 0.428 | 0.364 | 0.318 | 0.290 | 0.257 | 0.358 | 0.342 | 0.134 | 0.441 | 0.253 | 0.352 | 0.227 | 0.443 | 0.044 | 0.007 |
| C | 0.001 | 0.036 | 0.016 | 0.022 | 0.008 | 0.514 | 0.028 | 0.019 | 0.145 | 0.684 | 0.116 | 0.020 | 0.148 | 0.021 | 0.613 | 0.032 | 0.492 | 0.226 |

Next, the binary data of the time series data (A, B, C) is calculated, and the results are shown in [Table 11]. Among the components in [Table 10], those that are equal to or greater than a preset reference value (e.g., 0.5) are converted into 1, and if those are equal to or less than the reference value, they are converted into 0 using, for example, one-hot encoding. Each components of [Table 11] is as shown in FIG. 7.

TABLE 11

| t | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|
| A | 0 | 0 | 0 | 0 | 0 | 1 | 0 | 0 | 0 | 1 | 0 | 0 | 0 | 0 | 1 | 0 | 0 | 0 |
| B | 0 | 0 | 0 | 0 | 0 | 0 | 0 | 0 | 0 | 0 | 0 | 0 | 0 | 0 | 0 | 0 | 0 | 0 |
| C | 0 | 0 | 0 | 0 | 0 | 1 | 0 | 0 | 0 | 1 | 0 | 0 | 0 | 0 | 1 | 0 | 0 | 0 |

Next, the synchronization rate (sync) between the time series data (A, B, C) is calculated using the binary data of [Table 11].

The synchronization rate (sync(A, B)) of the time series data (A, B) is 0, and the synchronization rate (sync(B, C)) of the time series data (B, C) is 0. On the other hand, the synchronization rate (sync(A, C)) of the time series data (A, C) is 1 (∵sync(A, C)=3\hat{ }⅔*3)). The time series data (A, C) are in a state of being completely synchronized with each other.

As described above, the time series data (A, B) seem to be highly associated with each other (or the correlation coefficient is high) as in FIG. 5, but the synchronization rate (sync(A, B)) of the time series data (A, B) is 0. Rather, it may be seen that the time series data (A, C) are in a completely synchronized state.

The reason for this is as follows.

For example, the plurality of time series data acquired by the plurality of sensors installed in the substrate processing device include a value (influence 1) controlled by a recipe, and a value (influence 2) in which the chamber status during the process is reflected. Since (influence 1) is controlled by an external element, it is necessary to perform sensor clustering on the basis of (influence 2) that reflects an internal factor. The correlation coefficient may utilize, for example, a covariance such as a Pearson correlation coefficient, a similarity using Shapelet, or the like, but these largely reflect (influence 1) but hardly reflect (influence 2).

On the other hand, in some embodiments of the present invention, the frequency and location of occurrence (time point of occurrence) at which the singularity of the time series data occurs are used, rather than the overall shape (individual shape) of the time series data. For example, if the singularities of two time series data occur at the same time, it is considered that the singularities of the two time series data reflect the internal factors such as the chamber status. The more singularity that occur at the same time is, the more closely the two time series data are considered to be associated with each other. In addition, two sensors corresponding to the two time series data may be grouped into one group.

The binary data generated on the basis of the time series data indicates whether a singularity of the time series data has occurred and the time point of occurrence. In other words, if the binary data BD1={0, 1, 1, . . . , 0}, it indicates that no singularity has occurred at the first measurement time point, but a singularity has occurred at the second/third measurement time point. It is possible to check whether singularity have occurred simultaneously at the same measurement time point, by using the inner product of the binary data.

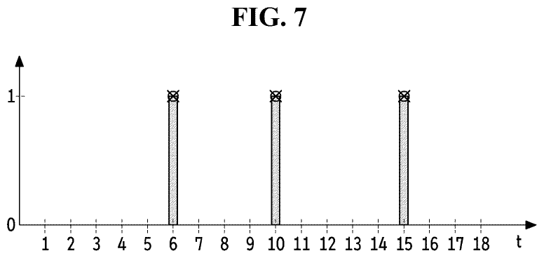

An example in which a source for providing the time series data is a sensor provided in the substrate processing device will be described below referring to FIGS. 8 to 10.

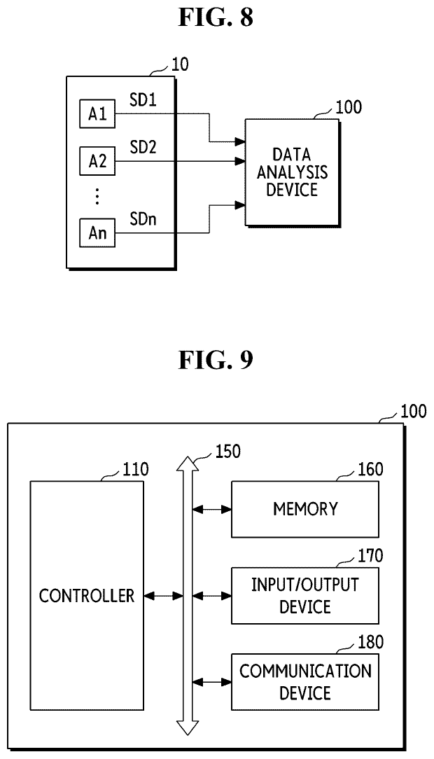

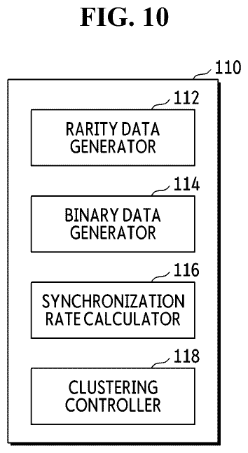

FIG. 8 is a block diagram that illustrates a relationship between a data analysis device and a substrate processing device according to some embodiments of the present invention. FIG. 9 is a block diagram that illustrates the data analysis device of FIG. 8. FIG. 10 is a block diagram that illustrates the controller of FIG. 9.

First, referring to FIG. 8, the substrate processing device 10 is provided with a plurality of sensors (A1, A2, . . . , An) (here, n is a natural number of 2 or more). The substrate processing device 10 may be any device used for processing the substrate, such as etching, photo, cleaning, baking, CMP (Chemical Mechanical Polishing), OHT (Overhead Hoist Transfer), and a moving robot.

The substrate processing device 10 may be provided with, for example, tens to hundreds of sensors (A1, A2, . . . , An). Each sensor (A1, A2, . . . , An) generates time series data (SD1, SD2, . . . , SDn) by performing a measurement operation for each preset time interval. For example, the measurement operation may be performed for each same time interval (for example, 0.1 seconds, 1 second).

The data analysis device 100 according to some embodiments of the present invention is provided with the time series data (SD1, SD2, . . . , SDn) from a plurality of sensors (A1, A2, . . . , An) and is configured to process and analyze the data. Depending on the analysis result, highly related sensors among the plurality of sensors (A1, A2, . . . , An) may be clustered.

Referring to FIG. 9, the data analysis device 100 includes a controller 110, a bus 150, a memory 160, an input/output device 170, a communication device 180, and the like.

The bus 150 allows various components such as the controller 110, the input/output device 170, the communication device 180, and the memory 160 to connect and communicate with each other (i.e., control message transfer and data transfer).

The controller 110 may include one or more of a central processing unit, an application processor or a communication processor (CP). The controller 110 may perform, for example, calculation or data processing related to control and/or communication of at least one other component of the data analysis device 100.

The input/output device 170 is a device for a user to input commands/data and output calculation results/data. For example, the input/output device 170 may be, but not limited to, a keyboard, a mouse, a display, and the like.

The communication device 180 allows the data analysis device 100 to communicate with a server or the like through a network. Here, the network includes both wired and wireless methods. In particular, the wireless communication may include cellular communication that uses at least one of, for example, an LTE, an LTE-A (LTE Advance), a CDMA (code division multiple access), a WCDMA (wideband CDMA), a UMTS (universal mobile telecommunications system), WiBro (Wireless Broadband), or A GSM (Global System for Mobile Communications). Alternatively, the wireless communication may include at least one of, for example, a WiFi (wireless fidelity), a LiFi (light fidelity), a Bluetooth, a Bluetooth low power (BLE), a Zigbee, a NFC (near field communication), a Magnetic Secure Transmission, a Radio Frequency (RF), or a Body Arca Network (BAN). Alternatively, the wireless communication may include a GNSS. The GNSS may be, for example, a GPS (Global Positioning System), a Glonass (Global Navigation Satellite System), a Beidou Navigation Satellite System (hereinafter “Beidou”), or a Galileo, the European global satellite-based navigation system. The wired communication may include, for example, at least one of a USB (universal serial bus), a HDMI (high definition multimedia interface), a RS-232 (recommended standard 232), a power line communication, or a POTS (plain old telephone service), a computer network (e.g., a LAN or a WAN), and the like.

The memory 160 may include a volatile memory (e.g., a DRAM, a SRAM, or a SDRAM) and/or a non-volatile memory (e.g., an one-time programmable ROM (OTPROM)), a PROM, an EPROM, an EEPROM, a mask ROM, a flash ROM, a flash memory, a PRAM, a RRAM, an MRAM, a hard drive, or a solid-state drive (SSD). The memory 160 may include an internal memory and/or an external memory. The memory 160 may store, for example, instructions or data related to at least one other component of the data analysis device 100. Additionally, the memory 160 may store software and/or programs.

The memory 160 stores instructions for executing the data analysis method described referring to FIGS. 1 to 7. For example, the memory 160 stores instructions for causing the controller 110 to perform the following operations.

A plurality of rarity data are generated on the basis of the plurality of time series data, each of which is acquired from a corresponding sensor among a plurality of sensors, and each rarity data indicates how rare each component data of the time series data is. Next, a plurality of binary data is generated on the basis of the plurality of rarity data. Next, a synchronization rate between the plurality of time series data is calculated, using the plurality of binary data. Next, the time series data whose calculated synchronization rate is greater than a preset reference value is determined to be in a state of being synchronized with each other. Next, the method includes clustering the sensors corresponding to the synchronized time series data. Here, the synchronization rate is calculated, using the inner product between the plurality of binary data represented by vectors. Here, generating of the rarity data means normalizing a plurality of component data of the time series data, estimating a probability density function associated with the plurality of component data, and calculating a rarity value using the rarity (Rarity(t, v)) defined by the above-mentioned [Formula 1] on the basis of the estimated probability density function. Here, when the synchronization rate may be calculated by the above-mentioned [Formula 2] in the case of two sensors (the first sensor, and the second sensor).

In other embodiments, the first rarity data is generated from a first time series data acquired from a first source, the first time series data includes a plurality of first component data acquired at a plurality of time points, and the first rarity data indicates how rare each of the plurality of first component data is. Then, the second rarity data is generated from a second time series data acquired from a second source, the second time series data includes a plurality of second component data acquired at a plurality of time points, and the second rarity data indicates how rare each of the plurality of second component data is. The first binary data is generated on the basis of the first rarity data, and the second binary data is generated on the basis of the second rarity data. Then, a synchronization rate between the first time series data and the second time series data is generated, using the first binary data and the second binary data. Here, generating of the first rarity data includes normalizing the plurality of first component data of the first time series data, estimating a probability density function associated with the plurality of first component data, and calculating the first rarity data on the basis of the estimated probability density function.

In other embodiments, the plurality of rarity data are generated on the basis of the plurality of time series data, each of which is acquired from a corresponding sensor among a plurality of sensors, and each rarity data indicates how rare each component data of the time series data is. Next, a plurality of binary data are generated on the basis of the plurality of rarity data. Next, a synchronization rate between the plurality of time series data is calculated, using the plurality of binary data. Time series data whose calculated synchronization rate is greater than a preset reference value are determined to be in a state of being synchronized with each other. Next, the sensors corresponding to the synchronized time series data are clustered.

Referring to FIG. 10, the controller 110 may include a rarity data generator 112, a binary data generator 114, a synchronization rate calculator 116, and a clustering controller 118.

The rarity data generator 112 normalizes the plurality of component data of the time series data, estimates a probability density function associated with the normalized component data, and calculates the rarity data on the basis of the estimated probability density function. Here, the plurality of component data are normalized using a hyperbolic tangent. Calculating of the rarity data includes calculating of the rarity value by the above-mentioned [Formula 1].

The binary data generator 114 uses one-hot encoding. For example, if the rarity data is a vector {R1, R2, R3, . . . , Rm}, the binary data generator 114 generates a vector {1−R1, 1−R2, 1−R3, . . . , 1−Rm} and performs one-hot encoding on each component of the vector {1−R1, 1−R2, 1−R3, . . . , 1-Rm} to generate binary data.

The synchronization rate calculator 116 calculates the synchronization rate, using the generated binary data. For example, if the first binary data is a first vector and the second binary data is a second vector, the synchronization calculator 116 may calculate the synchronization rate between the first time series data and the second time series data, using the inner product between the first vector and the second vector. The synchronization rate calculator 116 may calculate the synchronization rate using, for example, [Formula 2].

The clustering controller 118 determines that the time series data whose calculated synchronization rate is greater than a preset reference value are in a state of being synchronized with each other. Next, the clustering controller 118 clusters the sensors corresponding to the synchronized time series data.

In some embodiments, the clustering controller 118 may be further configured to initiate and/or perform a maintenance operation on one or more of the sensors (A1, A2, . . . , An) and/or one or more other components of the substrate processing device 10 based on any errors or abnormalities determined for any of the sources or sensors (A1, A2, . . . , An). These errors or abnormalities for a particular sensor may be based a singularity in the binary data BD corresponding to, for example, a measurement at a particular time point having a low rarity value, i.e., the measurement value was unexpected or usually not seen. Many sensors that are clustered together and having low rarity values at the same time may be indicative that there is a problem with the substrate processing device and not the individual sensors. But a single sensor with a low rarity value at a particular time or with many low rarity values may be indicative that the sensor needs maintenance or replacement.

Although the embodiments of the inventive concept have been described above with reference to the accompanying drawings, the present invention is not limited to the above embodiments, and may be fabricated in various different forms. Those skilled in the art will appreciate that the present invention may be embodied in other specific forms without changing the technical spirit or essential features of the present invention. Accordingly, the above-described embodiments should be understood in all respects as illustrative and not restrictive.

What is claimed is:

1. A method, comprising:
generating first rarity data from first time series data acquired from a first source of a substrate processing device, the first time series data including a plurality of first component data acquired at a plurality of time points, the first rarity data indicating how rare each of the plurality of first component data is;
generating second rarity data from second time series data acquired from a second source of the substrate processing device, the second time series data including a plurality of second component data acquired at a plurality of time points, the second rarity data indicating how rare each of the plurality of second component data is;
generating first binary data on the basis of the first rarity data;
generating second binary data on the basis of the second rarity data;
generating a synchronization rate between the first time series data and the second time series data, by using the first binary data and the second binary data; and
initiating a maintenance operation for the first source, the second source, or the substrate processing device based on the first binary data, the second binary data, and the synchronization rate.

2. The method of claim 1,
wherein the generation of the first rarity data comprises:
normalizing a plurality of first component data of the first time series data;
estimating a probability density function associated with the normalized plurality of first component data; and
calculating the first rarity data based on the estimated probability density function.

3. The method of claim 2,
wherein the normalization of the plurality of first component data comprises normalization using a hyperbolic tangent.

4. The method of claim 2,
wherein the calculation of the first rarity data comprises calculating a rarity value using a rarity (Rarity(t, v)) defined by [Formula 1], wherein [Formula 1] is
$$Rarity ( t , v ) = \frac{- log ( std ( t ) ) * pdfbox ( t , v ) + {e}^{- sensitivity}}{sensitivity}$$
std(t) represents a standard deviation of the first time series data,
pdfbox(t, v) represents the estimated probability density function, and
sensitivity represents a correction parameter of the first source.

5. The method of claim 1,
wherein the generation of the first binary data comprises generating the first binary data using one-hot encoding.

6. The method of claim 5,
wherein the first rarity data is a vector {R1, R2, R3, . . . , Rm}, and
generation of the first binary data comprises:
generating a vector {1−R1, 1−R2, 1−R3, . . . , 1−Rm}, and
performing one-hot encoding on each component of the vector {1−R1, 1−R2, 1−R3, . . . , 1−Rm}.

7. The method of claim 1,
wherein the first binary data is a first vector, and the second binary data is a second vector, and
a synchronization rate between the first time series data and the second time series data is calculated, using an inner product between the first vector and the second vector.

8. The method of claim 7,
wherein, when the first time series data is SD1, the second time series data is SD2, the first vector is BD1, the second vector is BD2, and < > indicates an inner product,
the synchronization rate sync(SD1, SD2) between the first time series data and the second time series data is calculated as:
$$sync ( SD 1 , SD 2 ) = \frac{{〈 BD 1 , BD 2 〉}^{2}}{〈 BD 1 , BD 1 〉 〈 BD 2 , BD 2 〉} .$$

9. The method of claim 1, further comprising:
clustering the first source and the second source, when the synchronization rate between the first time series data and the second time series data is greater than a preset reference value.

10. The method of claim 9, further comprising:
determining whether abnormal data is acquired from the second source, when abnormal data is acquired from the first source when the first source and the second source are clustered.

11. The method of claim 1,
wherein the plurality of first component data acquired at the plurality of time points are a plurality of first data acquired for each preset time interval.

12. A method, comprising:
generating a plurality of rarity data on the basis of a plurality of time series data sets, each of the plurality of time series data sets is acquired from a corresponding sensor among a plurality of sensors of a substrate processing device, and each rarity data item indicates how rare each corresponding component data item of the time series data is;
generating a plurality of binary data based on the plurality of rarity data;
calculating a synchronization rate between the plurality of time series data sets, using the plurality of binary data;
determining that ones of the plurality of time series data sets whose calculated synchronization rate is greater than a preset reference value are in a state of being synchronized with each other;
clustering sensors of the plurality of sensors corresponding to the synchronized ones of the plurality of time series data sets; and
initiating a maintenance operation for one or more of the plurality of sensors or the substrate processing device based on the plurality of binary data and the synchronization rate between the plurality of time series data sets,
wherein the calculation of the synchronization rate includes calculating an inner product between the plurality of binary data represented by vectors.

13. The method of claim 12,
wherein the generation of the rarity data comprises:
normalizing a plurality of component data of the time series data;
estimating a probability density function associated with the normalized plurality of component data; and
calculating a rarity value using the rarity (Rarity(t, v)) defined by [Formula 1] on the basis of the estimated probability density function,
wherein the [Formula 1] is
$$Rarity ( t , v ) = \frac{- log ( std ( t ) ) * pdfbox ( t , v ) + {e}^{- sensitivity}}{sensitivity}$$
std(t) indicates a standard deviation of the corresponding time series data,
pdfbox(t, v) represents the estimated probability density function, and
sensitivity represents a correction parameter of the corresponding sensor.

14. The method of claim 12,
wherein the generation of the plurality of binary data includes generating the plurality of binary data using one-hot encoding.

15. The method of claim 12,
wherein the plurality of sensors include a first sensor and a second sensor, the plurality of time series data sets include a first time series data set generated from the first sensor and a second time series data set generated from the second sensor, the plurality of binary data include first binary data corresponding to the first time series data set and second binary data corresponding to the second time series data set, the first binary data is represented by a first vector, and the second binary data is represented by a second vector,
in the calculation of the synchronization rate, when the first time series data set is SD1, the second time series data set is SD2, the first vector is BD1, the second vector is BD2, and < > indicates an inner product,
the synchronization rate sync(SD1, SD2) between the first time series data set and the second time series data set is calculated as follows:
$$sync ( SD 1 , SD 2 ) = \frac{{〈 BD 1 , BD 2 〉}^{2}}{〈 BD 1 , BD 1 〉 〈 BD 2 , BD 2 〉} .$$

16. The method of claim 12, further comprising:
determining whether abnormal data is acquired from remaining sensors among the clustered sensors when abnormal data is acquired from any of the clustered sensors.

17. A method, comprising:
generating a plurality of binary data corresponding to a plurality of sensors of a substrate processing device, the binary data indicating whether a singularity is sensed in the corresponding sensor and a time point at which the singularity is sensed;
determining a correlation between the corresponding plurality of sensors based on an inner product between the plurality of binary data;
clustering the sensors determined to be correlated; and
initiating a maintenance operation for one or more of the plurality sensors or the substrate processing device based on the binary data and the correlation between ones of the plurality of sensors.

18. The method of claim 17, further comprising:
determining whether abnormal data is acquired from remaining sensors among the clustered sensors, when abnormal data is acquired from any of the clustered sensors.

19. The method of claim 17,
wherein the plurality of sensors include a first sensor and a second sensor, first time series data is generated from the first sensor, second time series data is generated from the second sensor, the plurality of binary data include first binary data corresponding to the first time series data and second binary data corresponding to the second time series data, the first binary data is a first vector indicating a singularity sensing time point of the first time series data, and the second binary data is a second vector indicating a singularity sensing time point of the second time series data,
the determination of the correlation between the corresponding plurality of sensors includes calculating a synchronization rate sync(SD1, SD2) between the first time series data and the second time series data,
when the first time series data is SD1, the second time series data is SD2, the first vector is BD1, the second vector is BD2, and < > indicates an inner product,
the synchronization rate sync(SD1, SD2) between the first time series data and the second time series data is calculated as follows:
$$sync ( SD 1 , SD 2 ) = \frac{{〈 BD 1 , BD 2 〉}^{2}}{〈 BD 1 , BD 1 〉 〈 BD 2 , BD 2 〉} .$$

20. The method of claim 17,
wherein the binary data is generated based on time series data measured by a corresponding sensor of the plurality of sensors, and the method further comprising:
determining whether component data measured at a measured time point (t) of the time series data is a singularity based on component data measured at time points before the measured time point (t) or component data measured at time points after the measured time point (t).
